(19) United States
(12) Patent Application Publication
(10) Pub. No.: US 2025/0244540 A1
(43) Pub. Date: Jul. 31, 2025

(54) OPTICAL FIBER POLISHING JIG AND OPTICAL FIBER POLISHING DEVICE

(71) Applicant: SEIKOH GIKEN Co., Ltd., Matsudo-shi (JP)

(72) Inventors: Yuji SHIBUTANI, Matsudo-shi (JP); Shimpei OSHIDARI, Matsudo-shi (JP); Yuki TANAKA, Matsudo-shi (JP)

(21) Appl. No.: 18/954,556

(22) Filed: Nov. 21, 2024

(30) Foreign Application Priority Data
Jan. 25, 2024 (JP) 2024-009386

(51) Int. Cl. G02B 6/38

(52) U.S. Cl. CPC G02B 6/3863

(57) ABSTRACT

An optical fiber polishing jig used for polishing an optical fiber ferrule, the optical fiber polishing jig including: a jig body having an insertion hole into which the optical fiber ferrule can be inserted; a pivoting rod arranged on the jig body so that the pivoting rod can be pivoted with respect to the jig body around a rotating shaft portion; and a fixing piece configured to fix the optical fiber ferrule inserted into the insertion hole to the jig body when the pivoting rod is pivoted and the fixing piece is pressed by the pivoting rod and moved in response to the pivoting rod, wherein the pivoting rod has a hollow space in at least a part of a virtual area connecting the rotating shaft portion and a surface on which a force for pressing the fixing piece is applied when fixing the optical fiber ferrule.

### CROSS-REFERENCE TO RELATED APPLICATIONS

This patent specification is based on Japanese patent application, No. 2024-009386 filed on Jan. 25, 2024 in the Japan Patent Office, the entire contents of which are incorporated by reference herein.

### TECHNICAL FIELD

The present invention relates to an optical fiber polishing jig used for polishing an optical fiber and an optical fiber polishing device provided with the optical fiber polishing jig.

### BACKGROUND OF THE INVENTION

An optical fiber polishing jig having a plate-shape is used for fixing an optical fiber ferrule in which an optical fiber is held is used for polishing the optical fiber. Patent document 1 proposes the structure capable of fixing the optical fiber ferrule to the optical fiber polishing jig and releasing the optical fiber ferrule from the optical fiber polishing jig by moving a fixing piece installed movably to the optical fiber polishing jig by a pivoting rod. Because of this, the optical fiber ferrule can be attached and detached without using tools such as a wrench and a driver.

### PRIOR ART DOCUMENT

### Patent Documents

[Patent document 1] Japanese Patent No. 6192797

### SUMMARY OF THE INVENTION

In the optical fiber polishing jig described in Patent document 1, the load for fixing the optical fiber ferrule may be too large depending on the type (e.g., shape) of the optical fiber ferrule. Thus, the polishing characteristics may be deteriorated. If the space (clearance) between the pivoting rod and the fixing piece is manually adjusted to reduce the load, it takes time and the optical fiber ferrule cannot be fixed appropriately when the clearance is too large.

The present invention provides an optical fiber polishing jig capable of fixing and releasing the optical fiber ferrule only by the operation of the pivoting rod wherein an appropriate load can be applied to the optical fiber ferrule to fix the optical fiber ferrule by appropriately reducing the load for fixing the optical fiber ferrule.

The optical fiber polishing jig of the present invention is an optical fiber polishing jig used for polishing an optical fiber ferrule, the optical fiber polishing jig including: a jig body having an insertion hole into which the optical fiber ferrule can be inserted; a pivoting rod arranged on the jig body so that the pivoting rod can be pivoted with respect to the jig body around a rotating shaft portion; and a fixing piece configured to fix the optical fiber ferrule inserted into the insertion hole to the jig body when the pivoting rod is pivoted and the fixing piece is pressed by the pivoting rod and moved in response a movement of to the pivoting rod, wherein the pivoting rod has a hollow space in at least a part of a virtual area connecting the rotating shaft portion and an application surface on which a force for pressing the fixing piece is applied when fixing the optical fiber ferrule.

In the optical fiber polishing jig configured as described above, the hollow space is formed in the pivoting rod in at least a part of the area for supporting the load. Thus, the rigidity of the pivoting rod is lowered and the deformation of a tip of the pivoting rod is facilitated when the pivoting rod presses the fixing piece. Consequently, the load applied between the pivoting rod and the fixing piece is reduced without shortening the pressing length when the pivoting rod presses the fixing piece.

In the above described configuration, a plate spring can be provided as an energizing unit for energizing the fixing piece upward.

In the optical fiber polishing jig configured as described above, the fixing piece is energized upward by the plate spring. Thus, the fixing piece is moved toward the pivoting rod when the pressing force from the pivoting rod to the fixing piece is not generated for avoiding the interference between the fixing piece and the optical fiber ferrule. In the above described state, the optical fiber ferrule can be attached to the jig body and detached from the jig body.

In the above described configuration, the hollow space can be a notch formed from a part of an outer periphery of the pivoting rod to at least a part of the virtual area.

In the optical fiber polishing jig configured as described above, the notch is formed as the hollow space for lowering the rigidity of the pivoting rod is lowered.

In the above described configuration, the hollow space can be a hole which is not communicated with an outer periphery of the pivoting rod in a side view.

In the optical fiber polishing jig configured as described above, the hole is formed as the hollow space for lowering the rigidity of the pivoting rod.

In the above described configuration, a reinforcement member can be arranged in the hollow space.

In the optical fiber polishing jig configured as described above, the strength of the pivoting rod is reinforced by the reinforcement member while the rigidity of the pivoting rod is lowered by forming the hollow space.

In the above described configuration, the reinforcement member can be formed of a material with lower strength than a material of the pivoting rod.

In the optical fiber polishing jig configured as described above, the reinforcement member is formed of the material with lower strength than the material of the pivoting rod. Thus, the strength of the pivoting rod is not excessively reinforced.

In the above described configuration, the pivoting rod can be configured to press the fixing piece by a lower end of the pivoting rod when an upper end of the pivoting rod is pivoted downward.

In the optical fiber polishing jig configured as described above, the downward pivot in the pivoting movement of the pivoting rod is transferred to the fixing piece. On the contrary, when the pivoting rod is moved upward, the pressing force is not transferred from the pivoting rod to the fixing piece.

In the above described configuration, the jig body can include a plurality of insertion holes, and the pivoting rod and the fixing piece can be provided on each of the plurality of insertion holes.

In the optical fiber polishing jig configured as described above, the optical fiber ferrule is fixed to each of the plurality of insertion holes by using the pivoting rod and the fixing piece. Consequently, a plurality of optical fiber ferrules is fixed to the optical fiber polishing jig.

In the above described configuration, a raised portion can be annularly formed on an upper surface of the jig body, and the raised portion can include a first support portion for supporting the pivoting rod in a state that an upper end of the pivoting rod is pivoted upward, a second support portion for supporting the pivoting rod in a state that the upper end of the pivoting rod is pivoted downward and a pivot-opening which communicates with the first support portion and the second support portion for each of the plurality of insertion holes.

In the optical fiber polishing jig configured as described above, the pivoting rod is pivoted upward and downward in the pivot-opening provided on the raised portion. In addition, the pivoting rod can be supported by two positions of the first support portion and the second support portion. Thus, the pivoting rod can be positioned at the fixing position and the releasing position.

In the above described configuration, the optical fiber polishing jig can further include: a slide lock configured to be slid in an axial direction of the pivoting rod in a state of being inserted around the pivoting rod; a coil spring for energizing the slide lock toward a lower end of the pivoting rod; and a locking portion formed on the raised portion for locking a lower end of the slide lock.

In the optical fiber polishing jig configured as described above, the slide lock is locked to the support portion by the coil spring. Thus, the movement of the pivoting rod is prevented.

The present invention can be also achieved as an optical fiber polishing device provided with the optical fiber polishing jig.

The present invention can provide an optical fiber polishing jig capable of fixing and releasing the optical fiber ferrule only by the operation of the pivoting rod wherein an appropriate load can be applied to the optical fiber ferrule to fix the optical fiber ferrule while the load for fixing the optical fiber ferrule is appropriately reduced.

### BRIEF DESCRIPTION OF DRAWINGS

FIG. 1 is a perspective view showing a state that an optical fiber polishing jig is installed on an optical fiber polishing device.

FIG. 2 is a perspective view showing a state that the optical fiber polishing jig is detached from the optical fiber polishing device.

FIG. 3 is an enlarged perspective view of a raised portion.

FIG. 4 is a perspective view of a pivoting rod.

FIG. 5 is a side view of the pivoting rod.

FIG. 6 is a perspective view of a fixing piece.

FIG. 7 is a drawing showing a state that an optical fiber ferrule is released.

FIG. 8 is a drawing showing a state that the optical fiber ferrule is fixed to the jig body.

FIG. 9 is a drawing showing a state that the pivoting rod and the fixing piece are contacted with each other.

FIG. 10 is a side view of the pivoting rod of another embodiment.

FIG. 11 is a side view of the pivoting rod of another embodiment.

### DETAILED DESCRIPTION OF THE INVENTION

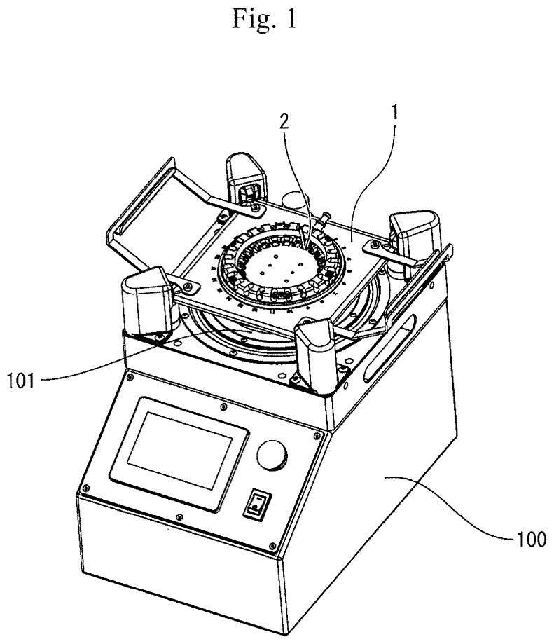

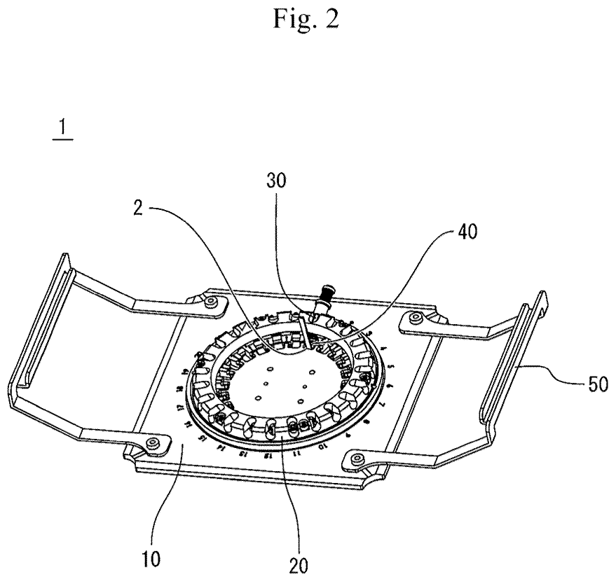

Hereafter, the embodiments of the present invention will be explained with reference to the drawings shown as an example. FIG. 1 is a perspective view showing a state that an optical fiber polishing jig 1 (hereafter, jig 1) is installed on an optical fiber polishing device 100 (hereafter, polishing device 100). FIG. 2 is a perspective view showing a state that the jig 1 is detached from the polishing device 100. The polishing device 100 includes a rotatably driven turntable 101 on an upper surface of the polishing device 100. An optical fiber ferrule 2 (hereafter, ferrule 2) is detachably attached to the jig 1 and the jig 1 is detachably attached to the polishing device 100. The ferrule 2 is an MT ferrule having a rectangular shape in a plan view. When the jig 1 is installed on the polishing device 100, the upper surface of the turntable 101 faces with the bottom surface of the jig 1. A polishing film or the like is arranged on the upper surface of the turntable 101 and the turntable 101 is rotationally driven. In the above described state, the ferrule 2 protruded downward from the bottom surface of the jig 1 is polished by the polishing film or the like. The detailed explanation of the structure of installing the jig 1 on the polishing device 100, the structure and operation of the polishing device 100 is omitted since the conventionally known technologies can be used.

As shown in FIG. 2, the jig 1 includes: a jig body 10 formed in a plate shape; a raised portion 20 formed on the upper surface of the jig body 10 so as to be protruded in an annular shape; a pivoting rod 30 arranged so as to be rotated with respect to the jig body 10 and the raised portion 20; a fixing piece 40 configured to be moved in response to the movement of the pivoting rod 30 for fixing the ferrule 2 to the jig body 10; and a pair of handles 50 to be grasped by an operator when the jig 1 is lifted up. Although only one ferrule 2 and one pivoting rod 30 are illustrated in FIG. 2 for facilitating the drawings, it is possible to annularly arrange a plurality of pivoting rods 30 and a plurality of fixing pieces 40, fix a plurality of ferrules 2 to the jig 1, and polish the plurality of ferrules 2 simultaneously.

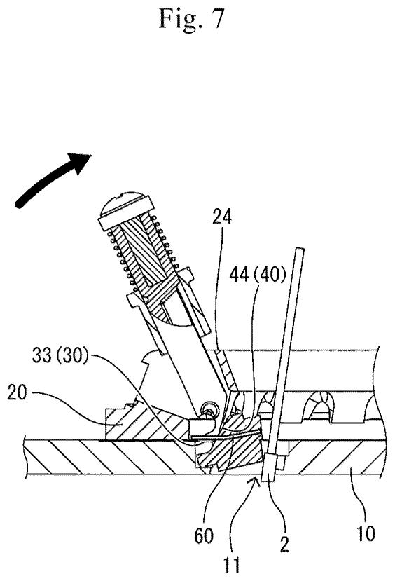

The jig body 10 is formed of metal such as aluminum and alloy or synthetic resin in an approximately rectangular shape in a plan view. As shown in FIG. 7 and the like, insertion holes 11 are formed on the jig body 10 so that the ferrule 2 can be inserted into each of the insertion holes 11. The insertion holes 11 are opened in a rectangular shape. The insertion holes 11 penetrate through the jig body 10 in the vertical direction. A plurality of insertion holes 11 are annularly arranged on the jig body 10. When the ferrule 2 is inserted into the insertion hole 11 and fixed by the fixing piece 40, the tip of the ferrule 2 is protruded downward from the bottom surface of the jig body 10 by a predetermined length. In the above described state, the tip of the ferrule 2 is polished by the polishing device 100.

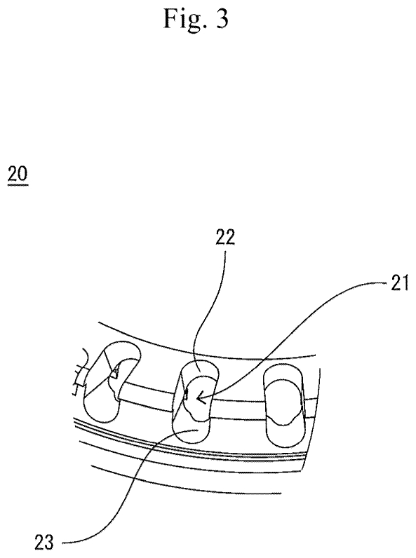

FIG. 3 is an enlarged perspective view of the raised portion 20. The raised portion 20 is formed of metal such as aluminum and alloy or synthetic resin in an annular shape (doughnut shape). The raised portion 20 is arranged on the upper surface of the jig body 10 and fixed to the jig body 10. The raised portion 20 includes pivot-openings 21 at the positions corresponding to the plurality of insertion holes 11. The pivoting rod 30 is arranged on each of the pivot-openings 21 so as to be pivotable with respect to the raised portion 20. Each of the pivot-openings 21 includes a first support portion 22 located at the inner side of the raised portion 20 in the radial direction and a second support portion 23 located at the outer side of the raised portion 20 in the radial direction. The first support portion 22 is formed by the wall surface extending in the vertical direction and having a semicircular shape in a plan view. When the upper end of the pivoting rod 30 is pivoted upward, the pivoting rod 30 abuts on the first support portion 22. Thus, the pivoting rod 30 is supported (positioned) at the upper position. The second support portion 23 is formed by the wall surface extending in the horizontal direction and having a semicircular shape in a side view. When the upper end of the pivoting rod 30 is pivoted downward, the pivoting rod 30 abuts on the second support portion 23. Thus, the pivoting rod 30 is supported (positioned) at the lower position. The pivot-opening 21 is communicated with the first support portion 22 and the second support portion 23.

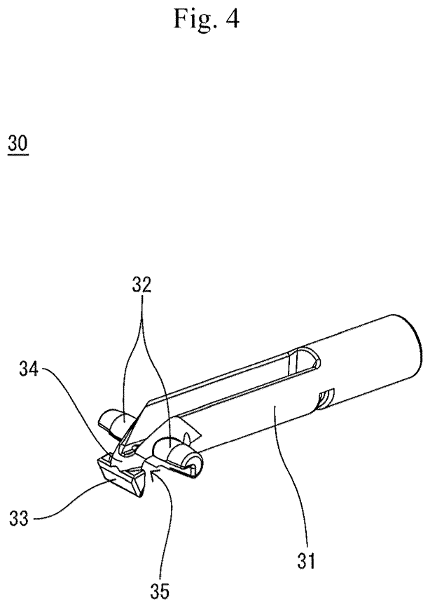

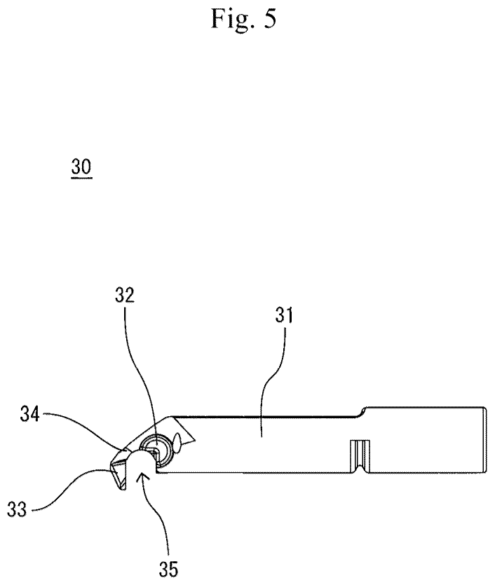

FIG. 4 is a perspective view of the pivoting rod 30. FIG. 5 is a side view of the pivoting rod 30. The pivoting rod 30 is formed of synthetic resin such as polyacetal resin (POM resin). The pivoting rod 30 includes: a body portion 31 having a cylindrical shape; a pair of rotating shaft portions 32 having a cylindrical shape extending in the horizontal direction from the body portion 31; a pressing portion 33 formed on the lower end of the body portion 31 and having a tip formed in a planar shape; and an intermediate portion 34 located between the rotating shaft portion 32 and the pressing portion 33. The lower end of the pivoting rod 30 is inserted in the pivot-opening 21 of the raised portion 20, and the pivoting rod 30 is supported by the wall surface between the first support portion 22 and the second support portion 23 of the raised portion 20 at the rotating shaft portion 32. When the operator operates the upper end of the pivoting rod 30 upward or downward, the pivoting rod 30 is pivoted with respect to the jig body 10 and the raised portion 20 around the rotating shaft portion 32. When the upper end of the pivoting rod 30 is pivoted downward (outward in radial direction), the pressing portion 33 abuts on the fixing piece 40 and presses the fixing piece 40 inward in the radial direction. When the upper end of the pivoting rod 30 is pivoted upward (inward in radial direction), the abutment between the pressing portion 33 and the fixing piece 40 is released. A notch (cutout) 35 is formed on the intermediate portion 34 between the pressing portion 33 and the rotating shaft portion 32 of the pivoting rod 30. The notch 35 is formed in an arc shape recessed inward from a part of the outer periphery of the intermediate portion 34. The details of the structure and function of the notch 35 will be described later.

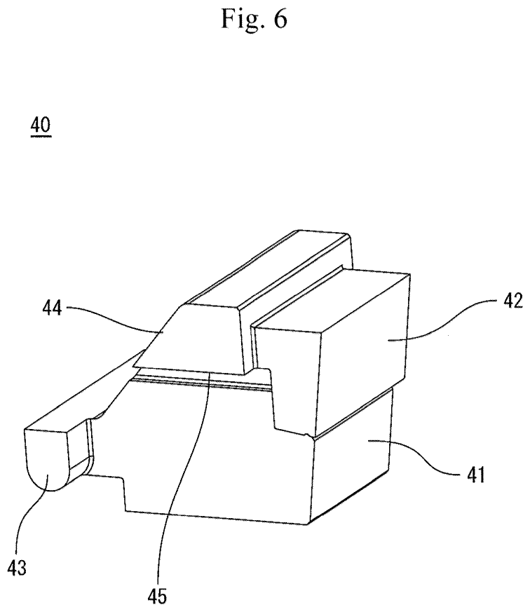

FIG. 6 is a perspective view of the fixing piece 40. The fixing piece is formed of synthetic resin such as polyacetal resin (POM resin). The fixing piece 40 includes: a side fixing portion 41 having a wall surface formed in the vertical direction and neighbored to the ferrule 2; an upper fixing portion 42 slightly protruded toward the ferrule 2 in the horizontal direction at the upper part of the side fixing portion 41; a rotating shaft portion 43 which functions as a rotation axis when the fixing piece 40 is rotated; an inclined portion 44 whose height is gradually increased from the upper fixing portion 42 to the rotating shaft portion 43; and a contact portion 45 configured to abut on a plate spring (flat spring) 60 as described later in FIG. 7 and the like. When the pivoting rod 30 is pivoted, the inclined portion 44 of the fixing piece 40 is pressed by the pressing portion 33 of the pivoting rod 30 and the fixing piece 40 is rotated around the rotating shaft portion 43. Consequently, the side fixing portion 41 presses the ferrule 2 from the side and the upper fixing portion 42 is arranged above the ferrule 2. Thus, the ferrule 2 is prevented from being removed upward. Namely, when the pivoting rod 30 is pivoted, the fixing piece 40 is pressed by the pivoting rod 30 and moved in response to the movement of the pivoting rod 30. Thus, the ferrule 2 inserted into the insertion hole 11 of the jig body 10 is fixed to the jig body 10. The contact portion 45 is protruded in the left-right direction at the lower part of the inclined portion 44. The fixing piece 40 is arranged so that the horizontal surface located at the lower surface of the contact portion 45 abuts on the plate spring 60.

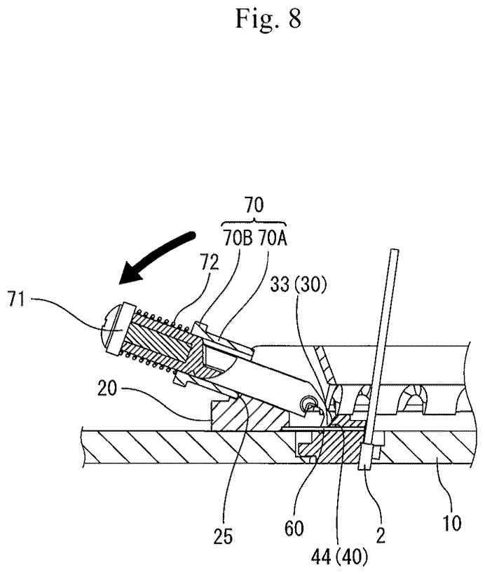

Hereafter, the operation of the components when the ferrule 2 is fixed to the jig body 10 by the pivoting rod 30 and the fixing piece 40 will be explained with reference to FIG. 7 and FIG. 8. FIG. 7 is a drawing showing a state that the ferrule 2 is released. The fixing piece 40 is arranged at the position neighbored to each of the insertion holes 11 for the ferrule 2 of the jig body 10. The pivoting rod 30 is installed so that the lower end of the pivoting rod 30 is located above the inclined portion 44 of the fixing piece 40. In the state shown in FIG. 7, the upper end of the pivoting rod 30 is pivoted upward as shown in the arrow mark. At this time, the pressing portion 33 located at the lower end of the pivoting rod 30 is moved outward (leftward in FIG. 7) of the jig body 10 in the radial direction. Thus, the pressing portion 33 does not abut on the inclined portion 44 of the fixing piece 40 and does not press the fixing piece 40. The plate spring 60 is arranged between the upper surface of the jig body 10 and the contact portion 45 of the fixing piece 40 as an energizing unit for energizing the fixing piece 40 upward. In the state shown in FIG. 7, the fixing piece 40 is rotated upward around the rotating shaft portion 43 by the plate spring 60. The side fixing portion 41 and the upper fixing portion 42 of the fixing piece 40 do not abut on the ferrule 2. Thus, the ferrule 2 can be attached and detached when the operator moves the ferrule 2 in the vertical direction.

FIG. 8 is a drawing showing a state that the ferrule 2 is fixed to the jig body 10. In the state shown in FIG. 8, the upper end of the pivoting rod 30 is pivoted downward as shown in the arrow mark. As the upper end of the pivoting rod 30 is pivoted downward, the pressing portion 33 located at the lower end of the pivoting rod 30 is gradually moved inward (rightward in FIG. 8) of the jig body 10 in the radial direction. At this time, the pressing portion 33 of the pivoting rod 30 presses the inclined portion 44 of the fixing piece 40. The fixing piece 40 pressed by the pivoting rod 30 is rotated (moved) inward in the radial direction of the jig body 10 around the rotating shaft portion 43 against the emerging force of the plate spring 60. In the state shown in FIG. 8, the side fixing portion 41 of the fixing piece 40 presses the side of the ferrule 2 and the upper fixing portion 42 is located above the ferrule 2. Thus, the ferrule 2 is fixed to the jig body 10. The length of the pivoting rod 30 from the rotating shaft portion 32 to the tip of the pressing portion 33 is specified slightly longer than the distance between the rotating shaft portion 32 and the inclined portion 44 of the fixing piece 40 in a state that the pivoting rod 30 presses the fixing piece 40. Consequently, when the pressing portion 33 and the inclined portion 44 are contacted with each other, the tip of the pivoting rod 30 is elastically deformed. The force generated by the elastic deformation is received by the rotating shaft portion 32. Thus, the pivoting rod 30 is not easily moved from the fixed state. The ferrule 2 is fixed to the jig body 10 in a state that the ferrule 2 is inclined by a predetermined angle with respect to the vertical direction. In this state, the ferrule 2 is polished (APC polishing).

A slide lock 70 formed in a cylindrical shape is inserted around the body portion 31 of the pivoting rod 30. In addition, a large diameter portion 71 having a larger diameter than the body portion 31 is fixed to the upper end of the pivoting rod 30. The slide lock 70 includes a body portion 70A and a knob portion 70B having a larger diameter than the body portion 70A. A coil spring 72 is arranged between the knob portion 70B and the large diameter portion 71 of the slide lock 70. The slide lock 70 is energized downward by the coil spring 72. Namely, the slide lock 70 is energized toward the lower end of the pivoting rod 30. When pivoting the upper end of the pivoting rod 30 upward (inward in radial direction), the operator grasps the knob portion 70B and slides the slide lock 70 upward to compress the coil spring 72. A first locking portion 24 located neighboring to the first support portion 22 and a second locking portion 25 located neighboring the second support portion 23 are formed on the raised portion 20. As shown in FIG. 7, when the operator releases a hand from the knob portion 70B in a state that the upper end of the pivoting rod 30 is pivoted upward (inward in radial direction), the slide lock 70 is pressed against the first locking portion 24 by the energizing force of the coil spring 72. Thus, the pivoting rod 30 is fixed. As shown in FIG. 8, when the operator releases a hand from the knob portion 70B in a state that the upper end of the pivoting rod 30 is pivoted downward, the slide lock 70 is pressed against the second locking portion 25 by the energizing force of the coil spring 72. Thus, the pivoting rod 30 is fixed. As explained above, the slide lock 70 is pressed against the first locking portion 24 or the second locking portion 25 by the energizing force of the coil spring 72. Thus, the pivot of the pivoting rod 30 is prevented and the fixed state of the ferrule 2 is maintained.

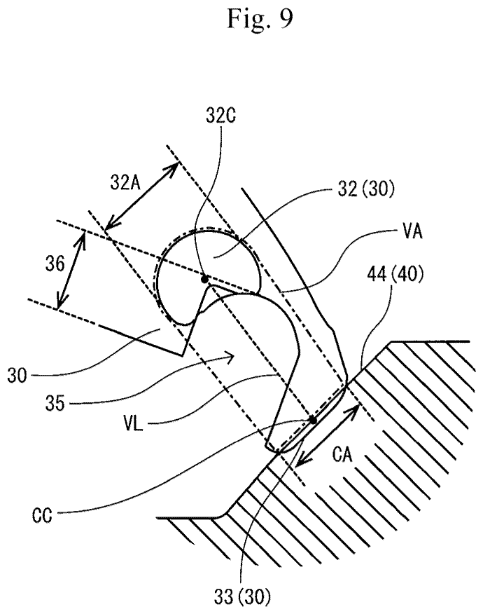

The structure and function of the notch 35 formed on the pivoting rod 30 will be explained with reference to FIG. 9. FIG. 9 is a drawing showing a state that the pivoting rod 30 and the fixing piece 40 are contacted with each other. A portion where the pressing portion 33 of the pivoting rod 30 and the inclined portion 44 of the fixing piece 40 are contacted is shown in an enlarged state. In FIG. 9, the pressing portion 33 and the inclined portion 44 are overlapped with each other. Actually, the tip of the pivoting rod 30 is elastically deformed toward the rotating shaft portion 32 by the width of the overlapped portion when the pressing portion 33 and the inclined portion 44 are contacted with each other. The tip of the pivoting rod 30 receives the force from the inclined portion 44 at the rotating shaft portion 32. In other words, the pivoting rod 30 presses the fixing piece 40. At this time, if the force of pressing the fixing piece 40 by the pivoting rod 30 is too strong, the influence to the polishing characteristics cannot be avoided. Thus, the required polishing characteristics cannot be obtained in some cases. This is because the ferrule 2 is fixed to the jig body 10 in a state that the shape of the ferrule 2 is deformed by the strong pressing force depending on the type (shape) of the ferrule 2. In order to solve the above described problem, the strength of the tip (lower end) portion of the pivoting rod 30 is lowered by forming the notch 35 on the pivoting rod 30 in the present invention. Since the strength of the pivoting rod 30 is lowered, the force of pressing the fixing piece 40 by the pivoting rod 30 can be reduced while keeping the clearance between the pivoting rod 30 and the fixing piece 40.

The notch 35 is a partly notched portion recessed inward (upward) from the bottom surface at the portion slightly upper than the tip of the pivoting rod 30 in the intermediate portion 34 between the pressing portion 33 and the rotating shaft portion 32. Namely, the notch 35 has a U-shape having an opening opened downward. An inlet portion (lower side) of the notch 35 has a straight shape while an inner portion (upper side) of the notch 35 has an arc shape. The position of forming the notch 35 is necessarily located at the position between the rotating shaft portion 32 which receives the load of fixing the ferrule 2 at the pivoting rod 30 side and the contact surface where the load is generated between the pivoting rod 30 and the fixing piece 40. Hereafter, the position of forming the notch 35 will be specifically explained more in detail. The area where the rotating shaft portion 32 is formed (width where the rotating shaft portion 32 is formed in FIG. 9) in the pivoting rod 30 is referred to as 32A. An application surface (contact area) where the pivoting rod 30 and the fixing piece 40 are contacted with each other when the fixing piece 40 is pressed by the pivoting rod 30 is referred to as CA. In addition, the center of the rotating shaft portion 32 in the width direction is referred to as 32C while the center of the application surface CA is referred to as CC. The notch 35 is formed in at least a part of a virtual area VA (area indicated by a dashed line in FIG. 9) connecting the area 32A of the rotating shaft portion 32 and the application surface CA. More preferably, the notch 35 is formed in at least a part of a virtual area connecting the center 32C of the rotating shaft portion 32 and the application surface CA. More preferably, the notch is formed in at least a part of a virtual line VL connecting the center 32C of the rotating shaft portion 32 and the center CC of the application surface CA.

The experiments were performed by preparing a plurality of samples of the pivoting rods 30 having different depth 36 of the notch 35 and comparing the change of the load generated at the tip of the pivoting rod 30 while changing the pressing amount pressing the tip of the pivoting rod 30. The result is shown in Table 1. In Table 1, “none” means the conventional product without forming a notch. The values shown in Table 1 show the load (kgf) generated at the tip of the pivoting rod 30 except for the pressing amount (mm) shown in the first column, the depth (mm) of the notch shown in the first to second rows and the ratio (%) shown in the last row. The ratio means the percentage of the load of each sample when the load of the pivoting rod 30 without the notch is 100%. The inner portion of the notch 35 was formed in an arc shape. The cell with a diagonal line means the condition where the value could not be measured since the load was too weak. From the experiment result shown in Table 1, it can be understood that the load generated at the tip of the pivoting rod 30 decreases as the depth of the notch increases. In the sample provided with the notch 35 having an arch shape of the depth of 1.5 mm, the load was 14% compared to the sample without the notch. Thus, the effect of the present invention of reducing the load for pressing the fixing piece 40 by the pivoting rod 30 was preferably exerted.

TABLE 1

| pressing | | | | | | | | |
|---|---|---|---|---|---|---|---|---|
| amount | depth of notch (mm) | | | | | | | |
| (mm) | None | 0.25 | 0.5 | 0.75 | 1.0 | 1.5 | 2.0 | 2.5 |
| 0.04 | 0.7 | 0.3 | 0.1 | 0.0 | −0.7 | | | |
| 0.05 | 1.3 | 0.9 | 0.8 | 0.5 | −0.4 | | | |
| 0.06 | 2.1 | 1.6 | 1.3 | 1.0 | −0.1 | 0.0 | | |
| 0.07 | 3.6 | 2.3 | 1.9 | 1.3 | 0.0 | 0.1 | | |
| 0.08 | 4.2 | 3.7 | 2.4 | 1.7 | 0.3 | 0.2 | | |
| 0.09 | 5.0 | 4.4 | 3.8 | 2.1 | 0.5 | 0.4 | | |
| 0.10 | 6.5 | 5.0 | 4.2 | 2.5 | 0.8 | 0.6 | | |
| 0.11 | 7.4 | 6.3 | 4.9 | 3.2 | 1.0 | 0.7 | | |
| 0.12 | 8.8 | 7.0 | 6.1 | 3.7 | 1.2 | 0.8 | | |
| 0.13 | 9.5 | 7.6 | 6.6 | 4.0 | 1.4 | 1.0 | | |
| 0.14 | 10.1 | 8.3 | 7.2 | 4.4 | 1.6 | 1.2 | | |
| 0.15 | 11.5 | 8.9 | 7.7 | 4.7 | 1.8 | 1.4 | | |
| 0.16 | 12.4 | 9.5 | 8.7 | 5.0 | 2.0 | 1.6 | | |
| 0.17 | 12.6 | 10.1 | 9.1 | 5.3 | 2.2 | 1.8 | | |
| 0.18 | 14.0 | 11.7 | 9.6 | 5.6 | 2.4 | 1.8 | | |
| 0.19 | 14.8 | 12.5 | 9.9 | 6.2 | 2.8 | 2.0 | 0.5 | 0.2 |
| 0.20 | 15.2 | 13.4 | 10.9 | 6.6 | 3.0 | 2.0 | 0.5 | 0.2 |
| ratio | 100% | 88% | 72% | 43% | 20% | 14% | 4% | 2% |

As explained above, in the jig 1 of the present invention shown in the embodiment, the notch 35 is provided in at least a part of the intermediate portion 34 between the pressing portion 33 and the rotating shaft portion 32 in the pivoting rod 30 and the intermediate portion 34 receives the load. Thus, the rigidity of the pivoting rod 30 against the load is lowered. Consequently, the deformation of a tip of the pivoting rod 30 is facilitated and the load applied to the fixing piece 40 is reduced when the pivoting rod 30 presses the fixing piece 40. Since the pivoting rod 30 does not press the fixing piece 40 excessively, the deterioration of the polishing characteristics can be prevented. In addition, it is not necessary to manually adjust the clearance between the pivoting rod 30 and the fixing piece 40. Thus, the ferrule 2 can be fixed surely without unnecessarily enlarging the clearance. By adopting the above described configuration, it is possible to provide the jig 1 capable of fixing various types of ferrules 2 appropriately. The above described feature is efficient especially for fixing a small ferrule 2. Even when there is an individual difference in a plurality of ferrules 2, the load for fixing the optical fiber ferrule 2 can be appropriately generated.

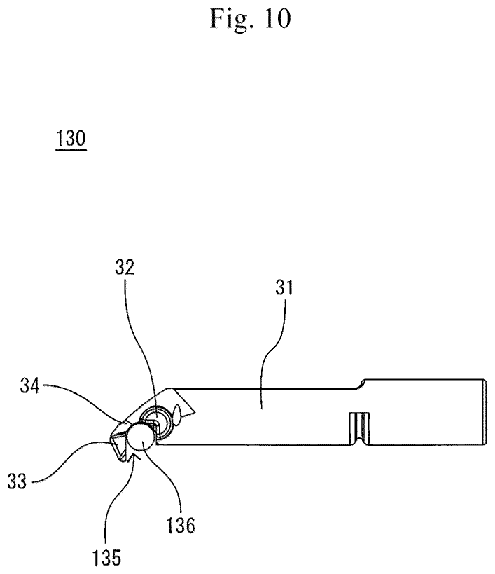

FIG. 10 is a side view of a pivoting rod 130 of another embodiment. A notch 135 is provided on the pivoting rod 130 similar to the pivoting rod 30. A reinforcement member 136 having a cylindrical shape is arranged inside the notch 135. The material of the reinforcement member 136 is made of the material (soft material) having lower strength than the material of the pivoting rod 130. For example, the pivoting rod 130 is formed of polyacetal resin (POM resin) and the reinforcement member 136 is formed of urethane resin. Consequently, a predetermined strength can be maintained while the rigidity of the pivoting rod 130 is lowered. The pivoting rod 130 has the same configurations as the pivoting rod 30 except for that the reinforcement member 136 is arranged inside the notch 135. Note that the reinforcement member 136 is not necessarily formed in a cylindrical shape. It is possible that the reinforcement member 136 fills a part of the notch 135. It is also possible that the reinforcement member 136 fills the entire space of the notch 135 using the reinforcement member 136 having an approximately same shape as the notch 135.

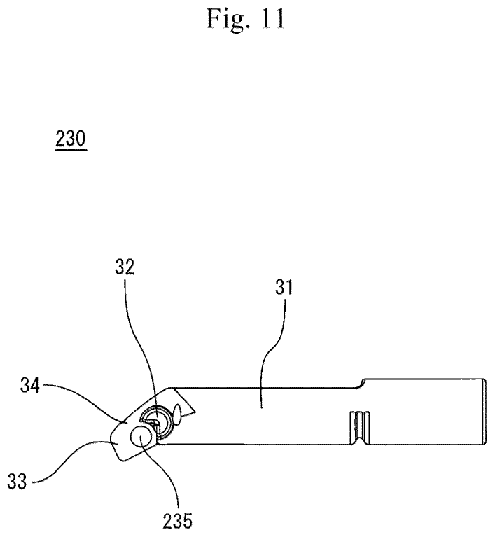

FIG. 11 is a side view of a pivoting rod 230 of another embodiment. A hole 235 is formed on the pivoting rod 230. The hole 235 is different from the notch 35 and the notch 135 in that the hole 235 is communicated with the outer periphery of the pivoting rod 230 in a side view. However, the hole 235 has the same effect as the notch 35 and the notch 135 in the sense that the rigidity of the pivoting rod 230 is lowered and the load applied to the fixing piece 40 is reduced. The effect of the present invention can be exhibited when the hollow space (cavity) such as the notch 35, notch 135 and the hole 235 is provided in the application point for applying the force for pressing the fixing piece 40 by the rotating shaft portion 32 of the pivoting rods 30, 130, 230. Namely, the hollow space is the concept including the notch and the hole. The pivoting rod 230 has the same configuration as the pivoting rod 30 except for that the hole 235 is formed instead of the notch 35. The position of forming the hole 235 is same as the position of forming the notch 35. The hole 235 is formed in at least a part of the virtual area VA connecting the area 32A and the application surface CA as shown in FIG. 9A. More preferably, the hole 235 is formed in at least a part of the virtual area connecting the center 32C of the rotating shaft portion 32 and the application surface CA. More preferably, the hole 235 is formed in at least a part of the virtual line VL connecting the center 32C of the rotating shaft portion 32 and the center CC of the application surface CA.

In the above described embodiment, the MT ferrule having a rectangular shape in a plan view is exemplified. However, the type of the ferrule is not limited to the MT ferrule. The present invention can be applied as long as the ferrule incorporating the optical fiber is fixed to the jig for polishing the ferrule.

In the above described embodiment, the configuration of forming the raised portion 20 in annular shape and annually fixing the ferrules 2 to the jig 1 is explained. However, the arrangement of the ferrules is not limited to the above described configuration. For example, it is also possible to linearly form the raised portion on the jig body 10 and linearly arrange a plurality of ferrules on the jig body 10. It is also possible to directly arrange the pivoting rod and the like on the jig body without forming the raised portion.

In the above described embodiment, the configuration of pressing the fixing piece 40 by the lower end of the pivoting rod 30 when the upper end of the pivoting rod 30 is pivoted downward is explained. However, it is also possible to adopt the configuration of pressing the fixing piece 40 by the lower end of the pivoting rod 30 when the upper end of the pivoting rod 30 is pivoted upward.

In the above described embodiment, the configuration of using the plate spring 60 as the energizing unit for energizing (biasing) the fixing piece 40 upward is explained. However, the energizing (biasing) mechanism is not limited to the plate spring. It is also possible to use the coil spring or elastic members such as rubber and resin instead of the plate spring.

In the above described embodiment, the explanation is made by using the jig used for the APC polishing where the ferrule 2 is inclined by a predetermined angle with respect to the vertical direction. However, the usage of the jig of the present invention is not limited to the APC polishing. The jig of the present invention is also effective for the flat surface polishing where the ferrule is arranged in the vertical direction to be polished.

In the above described embodiment, the configuration for preventing the pivot of the pivoting rod 30 using the slide lock 70, the coil spring 72, the first locking portion 24 and the second locking portion 25 is explained. However, it is not necessary to use the above described configuration. The pivot of the pivoting rod 30 can be prevented by the force of the elastic deformation of the pivoting rod 30 generated by the contact between the pivoting rod 30 and the fixing piece 40 by the rotating shaft portion 32.

In the above described embodiment, the explanation is made by exemplifying the notches 35, 135 and the hole 235 as the example of the hollow space. The shape of the notch and the hole is not limited to the shape described in the embodiment. In addition, the hollow space other than the notch and the hole is also included in the present invention. Here, the hollow space is the space intentionally formed in terms of design. For example, the hollow space of the present invention does not intend to include the hollow space inevitably formed inside the resin when cooling the resin if the pivoting rod is formed of resin.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

### DESCRIPTION OF THE REFERENCE NUMERALS

1: optical fiber polishing jig, 2: optical fiber ferrule, 10: jig body, 11: insertion hole, 20: raised portion, 21: pivot-opening, 22: first support portion, 23: second support portion, 24: first locking portion, 25: second locking portion, 30: pivoting rod, 31: body portion, 32: rotating shaft portion, 33: pressing portion, 34: intermediate portion, 35: notch, 36: depth of notch, 40: fixing piece, 41: side fixing portion, 42: upper fixing portion, 43: rotating shaft portion, 44: inclined portion, 45: contact portion, 50: handle, 60: plate spring, 70: slide lock, 71: large diameter portion, 72: coil spring, 100: optical fiber polishing device, 101: turntable, 130: pivoting rod, 135: notch, 136: reinforcement member, 230: pivoting rod, 235: hole

1. An optical fiber polishing jig used for polishing an optical fiber ferrule, the optical fiber polishing jig comprising:
a jig body having an insertion hole into which the optical fiber ferrule can be inserted;
a pivoting rod arranged on the jig body so that the pivoting rod can be pivoted with respect to the jig body around a rotating shaft portion; and
a fixing piece configured to fix the optical fiber ferrule inserted into the insertion hole to the jig body when the pivoting rod is pivoted and the fixing piece is pressed by the pivoting rod and moved in response to the pivoting rod, wherein
the pivoting rod has a hollow space in at least a part of a virtual area connecting a center of the rotating shaft portion and a surface on which a force for pressing the fixing piece is applied when fixing the optical fiber ferrule.

2. The optical fiber polishing jig according to claim 1, wherein
a plate spring is provided as an energizing unit for energizing the fixing piece upward.

3. The optical fiber polishing jig according to claim 1, wherein
the hollow space is a notch formed from a part of an outer periphery of the pivoting rod to at least a part of the virtual area.

4. An optical fiber polishing jig used for polishing an optical fiber ferrule, the optical fiber polishing jig comprising:
a jig body having an insertion hole into which the optical fiber ferrule can be inserted;
a pivoting rod arranged on the jig body so that the pivoting rod can be pivoted with respect to the jig body around a rotating shaft portion; and
a fixing piece configured to fix the optical fiber ferrule inserted into the insertion hole to the jig body when the pivoting rod is pivoted and the fixing piece is pressed by the pivoting rod and moved in response to the pivoting rod, wherein
the pivoting rod has a hollow space in at least a part of a virtual area connecting the rotating shaft portion and a surface on which a force for pressing the fixing piece is applied when fixing the optical fiber ferrule, and
the hollow space is a hole which is not communicated with an outer periphery of the pivoting rod in a side view.

5. An optical fiber polishing jig used for polishing an optical fiber ferrule, the optical fiber polishing jig comprising:
a jig body having an insertion hole into which the optical fiber ferrule can be inserted;
a pivoting rod arranged on the jig body so that the pivoting rod can be pivoted with respect to the jig body around a rotating shaft portion; and
a fixing piece configured to fix the optical fiber ferrule inserted into the insertion hole to the jig body when the pivoting rod is pivoted and the fixing piece is pressed by the pivoting rod and moved in response to the pivoting rod, wherein
the pivoting rod has a hollow space in at least a part of a virtual area connecting the rotating shaft portion and a surface on which a force for pressing the fixing piece is applied when fixing the optical fiber ferrule, and
a reinforcement member is arranged in the hollow space.

6. The optical fiber polishing jig according to claim 5, wherein
the reinforcement member is formed of a material with lower strength than a material of the pivoting rod.

7. The optical fiber polishing jig according to claim 1, wherein
the pivoting rod is configured to press the fixing piece by a lower end of the pivoting rod when an upper end of the pivoting rod is pivoted downward.

8. The optical fiber polishing jig according to claim 1, wherein
the jig body includes a plurality of insertion holes, and
the pivoting rod and the fixing piece are provided on each of the plurality of insertion holes.

9. The optical fiber polishing jig according to claim 8, wherein
a raised portion is annularly formed on an upper surface of the jig body, and
the raised portion includes a first support portion for supporting the pivoting rod in a state that an upper end of the pivoting rod is pivoted upward, a second support portion for supporting the pivoting rod in a state that the upper end of the pivoting rod is pivoted downward and a pivot-opening which communicates with the first support portion and the second support portion for each of the plurality of insertion holes.

10. The optical fiber polishing jig according to claim 9, further comprising:
a slide lock configured to be slid in an axial direction of the pivoting rod in a state of being inserted around the pivoting rod;
a coil spring for energizing the slide lock toward a lower end of the pivoting rod; and
a locking portion formed on the raised portion for locking a lower end of the slide lock.

11. An optical fiber polishing device provided with the optical fiber polishing jig according to claim 1.
